(19) United States
(12) Patent Application Publication
(10) Pub. No.: US 2025/0281832 A1
(43) Pub. Date: Sep. 11, 2025

(54) SYSTEMS AND METHODS FOR CUSTOMIZING ONLINE GAMING

(71) Applicant: Magnetic Games AB, Malmö (SE)

(72) Inventors: David Nelson, Malmo (SE); Alexander Hartley, Malmo (SE); Alex Bagnolini, San Mauro Pascoli (IT); Peter Chung, Los Angeles, CA (US); Jesus Lou Cuatero, Barcelona (ES)

(21) Appl. No.: 19/073,748

(22) Filed: Mar. 7, 2025

Related U.S. Application Data
(60) Provisional application No. 63/562,593, filed on Mar. 7, 2024.

(51) Int. Cl. A63F 13/52

(52) U.S. Cl. CPC A63F 13/52

(57) ABSTRACT

A method for customizing the appearance of a digital game includes receiving content from a user, analyzing the content to identify at least one content feature, obtaining at least one custom game element corresponding to the at least one content feature, and generating a custom appearance scheme for the digital game that includes the at least one custom game element.

### CROSS-REFERENCE TO RELATED APPLICATIONS

This application claims priority to and the benefit of U.S. Provisional Patent Application No. 63/562,593 titled “SYSTEMS AND METHODS FOR CUSTOMIZING ONLINE GAMING” and filed on Mar. 7, 2024, the entire contents of which is hereby incorporated by reference herein.

### TECHNICAL FIELD

This specification relates to the customization of online (or digital) games and, in particular, generating custom appearance schemes for digital games based on content provided by users.

### BACKGROUND

Digital games employ a wide range of visual styles, from pixel art to hyper-realistic three-dimensional (3D) graphics. While some elements, such as resolution and brightness, can be adjusted by the user, the overall appearance of the game is generally not customizable beyond what developers provide. Users may have options to tweak settings like character skins in some games, but the core visual design (e.g., textures, coloring, and aesthetics) typically remain fixed.

### SUMMARY

At least one aspect of the present disclosure is directed to a method for customizing the appearance of a digital game. The method includes receiving content from a user, analyzing the content to identify at least one content feature, obtaining at least one custom game element corresponding to the at least one content feature, and generating a custom appearance scheme for the digital game that includes the at least one custom game element.

In some embodiments, the method includes applying the custom appearance scheme to a level of the digital game. In some embodiments, the method includes obtaining a default appearance scheme for the digital game including a plurality of default game elements, wherein generating the custom appearance scheme for the digital game includes replacing at least one default game element with the at least one custom game element. In some embodiments, obtaining the at least one custom game element includes selecting the at least one custom game element from a game element library. In some embodiments, the game element library is stored in at least one database. In some embodiments, obtaining the at least one custom game element includes generating the at least one custom game element.

In some embodiments, the method includes evaluating the at least one content feature to determine if the at least one content feature corresponds to licensed content and in response to a determination that the at least one content feature corresponds to licensed content, determining whether the digital game has a license to use the licensed content. In some embodiments, determining whether the digital game has a license to use the licensed content includes querying at least one database. In some embodiments, the content includes a video, an image, a GIF, or any combination thereof. In some embodiments, the content features include items represented in the content, entities associated with the content, colors represented in the content, text represented in the content, or any combination thereof. In some embodiments, the at least one custom game element includes pieces, icons, characters, scenery, colors, or any combination thereof.

Another aspect of the present disclosure is directed to a system for customizing the appearance of a digital game. The system includes at least one memory for storing computer-executable instructions and at least one processor for executing the instructions stored on the at least one memory. Execution of the instructions programs the at least one processor to perform operations that include receiving content from a user, analyzing the content to identify at least one content feature, obtaining at least one custom game element corresponding to the at least one content feature, and generating a custom appearance scheme for the digital game that includes the at least one custom game element.

In some embodiments, the instructions, when executed, further instruct the at least one processor to perform operations that include applying the custom appearance scheme to a level of the digital game. In some embodiments, the instructions, when executed, further instruct the at least one processor to perform operations that include obtaining a default appearance scheme for the digital game including a plurality of default game elements, wherein generating the custom appearance scheme for the digital game includes replacing at least one default game element with the at least one custom game element. In some embodiments, obtaining the at least one custom game element includes selecting the at least one custom game element from a game element library. In some embodiments, the game element library is stored in at least one database. In some embodiments, obtaining the at least one custom game element includes generating the at least one custom game element.

In some embodiments, the instructions, when executed, further instruct the at least one processor to perform operations that include evaluating the at least one content feature to determine if the at least one content feature corresponds to licensed content and in response to a determination that the at least one content feature corresponds to licensed content, determining whether the digital game has a license to use the licensed content. In some embodiments, determining whether the digital game has a license to use the licensed content includes querying at least one database. In some embodiments, the content includes a video, an image, a GIF, or any combination thereof. In some embodiments, the content features include items represented in the content, entities associated with the content, colors represented in the content, text represented in the content, or any combination thereof. In some embodiments, the at least one custom game element includes pieces, icons, characters, scenery, colors, or any combination thereof.

### BRIEF DESCRIPTION OF THE DRAWINGS

FIG. 1 illustrates a block diagram of a digital game system in accordance with aspects described herein;

FIG. 2 illustrates a flow diagram of a method for generating a custom appearance scheme using the system of FIG. 1, in accordance with aspects described herein;

FIG. 3 illustrates an example graphical user interface (GUI) presented on a user device, in accordance with aspects described herein;

FIG. 4 illustrates an example GUI presented on a user device, in accordance with aspects described herein;

FIG. 5 illustrates an example of tags assigned by a content analyzer of the system of FIG. 1, in accordance with aspects described herein;

FIG. 6 illustrates an example GUI presented on a user device, in accordance with aspects described herein;

FIG. 7 illustrates an example GUI presented on a user device, in accordance with aspects described herein;

FIG. 8A illustrates an example of a custom appearance scheme generated by an element engine of the system of FIG. 1, in accordance with aspects described herein;

FIG. 8B illustrates an example of a custom appearance scheme generated by an element engine of the system of FIG. 1, in accordance with aspects described herein;

FIG. 8C illustrates an example of a custom appearance scheme generated by an element engine of the system of FIG. 1, in accordance with aspects described herein;

FIG. 9 illustrates an example GUI presented on a user device, in accordance with aspects described herein;

FIG. 10 illustrates an example GUI presented on a user device, in accordance with aspects described herein; and

FIG. 11 illustrates an example computing device in accordance with aspects described herein.

### DETAILED DESCRIPTION

Disclosed herein are exemplary embodiments of systems and methods for customizing online (or digital) games. In particular, described are various embodiments of a system that generates custom appearance schemes for digital games based on content provided by users.

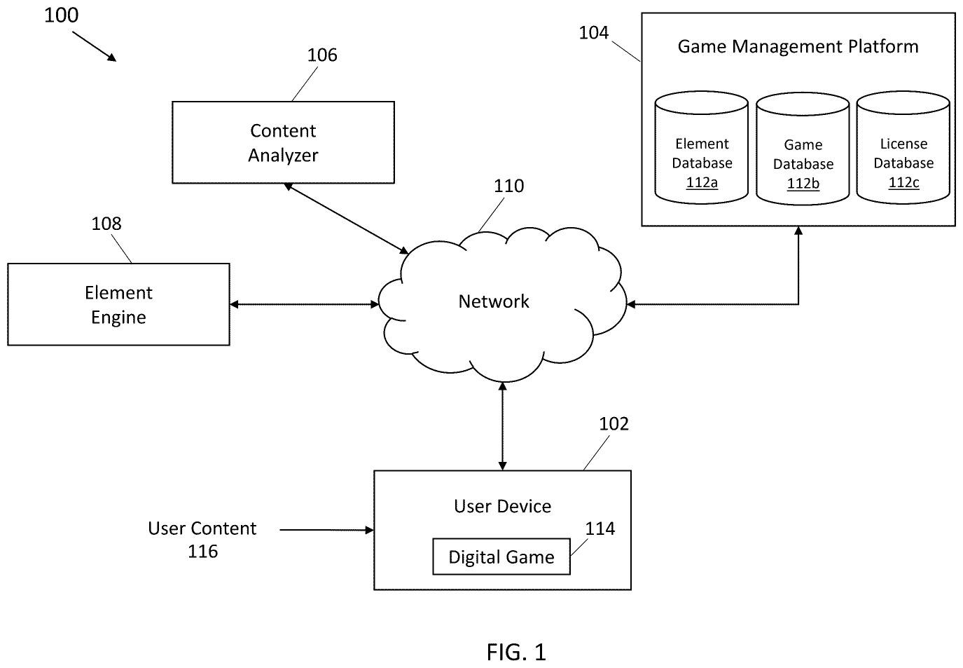

FIG. 1 is a block diagram of a digital game system 100 in accordance with aspects described herein. In one example, the system 100 includes a user device 102, a game management platform (GMP) 104, a content analyzer 106, and an element engine 108. The user device 102, the GMP 104, the content analyzer 106, and the element engine 108 are configured to communicate via a wired and/or wireless network 110. In some examples, the GMP 104 is implemented on one or more cloud-based servers. As shown, the GMP 104 includes (or is configured to communicate with) a plurality of databases 112. In one example, the plurality of databases 112 includes an element database 112a, a game database 112b, and a license database 112c, which are described in greater detail below. In some examples, the content analyzer 106 and/or the element engine 108 are located in the GMP 104. Alternatively, the content analyzer 106 and/or the element engine 108 may be located on the user device 102 or on a server different from the GMP 104.

A digital game 114 is configured to run (or operate) on the user device 102. The user device 102 includes handheld devices (e.g., cell phones, smartphones, tablets, etc.), computers (e.g., laptops, desktops, etc.), virtual or augmented reality devices, game consoles, or any other suitable devices for playing digital games. In some examples, at least a portion of the digital game 114 is downloaded on the user device 102 (e.g., saved in memory on the user device 102). In some examples, the digital game is a cloud-based game that is accessed via the user device 102. In some examples, at least a portion of the digital game 114 is stored on a local medium (e.g., a disk, cartridge, or external storage device). In some examples, the digital game 114 is a single-player game (e.g., played locally on the user device 102). In other examples, the digital game 114 is a multi-player game that is played with other local and/or remote users. In some examples, the digital game 114 supports both single player mode and multi-player mode.

The digital game 114 may be any type of game. For example, the digital game 114 may be a puzzle game that challenge players with solving problems or completing tasks using logic, strategy, and critical thinking skills. The digital game 114 may be a racing game that focus on speed and competition, often featuring vehicles ranging from cars and motorcycles to futuristic spacecraft. The digital game 114 may be an action-adventure game that combines elements of both action and exploration, immersing players in narratives and expansive worlds to uncover secrets and defeat enemies. The digital game 114 may be a role-playing game (RPG) that allows players to assume the roles of characters within intricate storylines, leveling up their abilities and making choices that shape the game world. The digital game 114 may be a simulation game that offers realistic experiences in various fields such as life, flight, farming, and city-building, allowing players to simulate real-life activities and scenarios. The digital game 114 may be a strategy game that emphasizes tactical decision-making and resource management, challenging players to outsmart opponents and achieve specific objectives. Additionally, the digital game 114 may fall into other gaming genres such as sports, casino games, platformers, fighting games, multiplayer online battle arenas, or any other suitable game genre.

The user device 102 is configured to receive user content 116 that is used to customize the digital game 114. The user content 116 includes a video, an image, a GIF, music, a non-fungible token (NFT), or any other suitable type of content. The user content 116 can include combinations of content (e.g., a video and an image). In some examples, the user content 116 is captured via the user device 102. For example, the user may operate the user device 102 to take a picture or record a video. In some examples, the user content 116 may be obtained from an external source (e.g., the internet) via the user device 102 or another device. In some examples, the user content 116 is purchased by the user via one or more content marketplaces. In some examples, the user content 116 is provided to the user. For example, the user content 116 may include geo-triggered content. In such examples, the user content 116 is made available to the user after visiting a specific geographic location (e.g., an arena, a concert, a city, etc.). In some examples, the user content 116 is provided to the user by the digital game 114 (e.g., in response to an achievement, score, etc.). In some examples, the user receives the content 116 from another user (local or remote) via a gift, trade, or purchase transaction.

In some examples, the system 100 is configured to customize the digital game 114 by generating a custom appearance scheme based on the user content 116. In one example, the custom appearance scheme corresponds to a “digital skin” that is applied to the digital game 114. In some examples, the custom appearance scheme is applied to discrete aspects of the game. For example, the custom appearance scheme may apply to an individual level (or a set of levels) of the digital game 114. Likewise, the custom appearance scheme may apply to different worlds or environments of the digital game 114. In some examples, the custom appearance scheme applies to portions of the digital game 114 involving specific characters or avatars. In some examples, the custom appearance scheme applies to portions of the digital game 114 involving specific plots, scenes, narratives, quests, missions, or challenges.

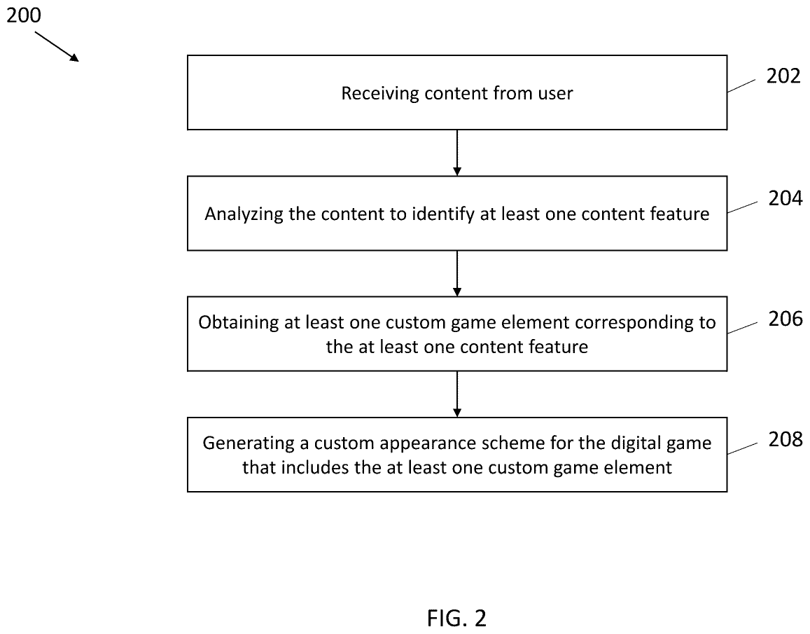

FIG. 2 illustrates a flow diagram of a method 200 for generating a custom appearance scheme using the system 100.

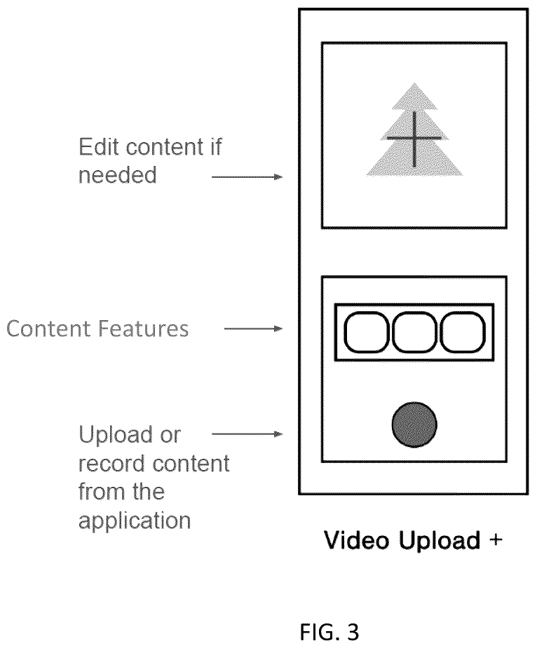

At block 202, the user device 102 receives the user content 116. As discussed above, the user content 116 may be captured or otherwise obtained via the user device 102. FIG. 3 illustrates an example graphical user interface (GUI) presented on the user device 102. In some examples, the GUI is part of the digital game 114; however, in other examples, the GUI may be part of different software on the user device 102. As shown, the GUI includes a button that enables the user to collect or record the user content 116 using the user device 102 (e.g., via a camera of the user device 102). In some examples, the GUI includes a button that enables the user to upload the user content 116. Additionally, the GUI may include a preview window that enables the user to view the user content 116.

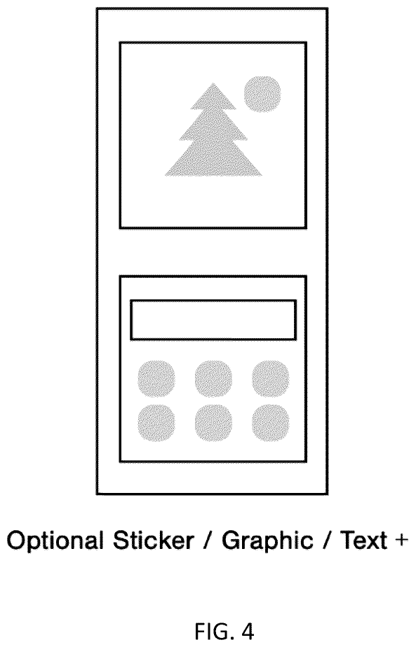

In some examples, the GUI includes one or more tools for editing the user content 116. For example, the GUI may include tools that enable the user to position, re-size, and/or crop the user content 116. In some examples, the GUI includes tools that enable the user to apply filters (e.g., colors, lighting, etc.) to the user content 116. As shown in FIG. 4, the GUI may include tools that enable the user to add additional content to the user content 116. For example, the user may add stickers, graphics, text, or any other suitable type of content to the user content 116. In some examples, the user device 102 (or the digital game 114) is configured to obtain the additional content from a content library stored in a database (e.g., the game database 112b).

At block 204, the content analyzer 106 analyzes the user content 116 to identify at least one content feature. The content features include items represented in the content, entities associated with the content, colors represented in the content, and text represented in the content. In some examples, the user content 116 is provided from the user device 102 to the content analyzer 106 (e.g., via the network 110) for analysis. In some examples, the content analyzer 106 uses image recognition techniques (or tools) to identify the content features present in the user content 116. The content analyzer 106 may include, or interface with, third-party image recognition tools (e.g., Open AI's GPT Vision tool or Amazon Rekognition). In some examples, the content analyzer 106 is configured to analyze the user content 116 as a whole (e.g., the entire image, the full video, etc.). In some examples, the content analyzer 106 analyzes the user content 116 in sections. For example, if the user content 116 is a video, the content analyzer 106 may analyze the user content 116 on a frame-by-frame basis. Alternatively, the content analyzer 106 may analyze the video frames in groups (e.g., 3 frames, 10 frames, etc.). In some examples, the identified content features are presented to the user via the GUI (e.g., see FIG. 3).

In some examples, the content analyzer 106 is trained (or otherwise instructed) to identify content features based on a predefined list of categories. Such categories may correspond to objects, items, entities, people, brands, and locations included in the content. In addition, the categories may correspond to actions, movements, and events occurring in the content. In some examples, the categories correspond to stylistic attributes of the content, such as colors, camera angles, zoom level, etc. In one example, the predefined categories include categories such as main subjects, secondary subjects, activities, mood/atmosphere, setting/environment, season/weather, region/geography, time of day, camera view, and colors. However, it should be appreciated that this list of categories is an example and that different categories may be used.

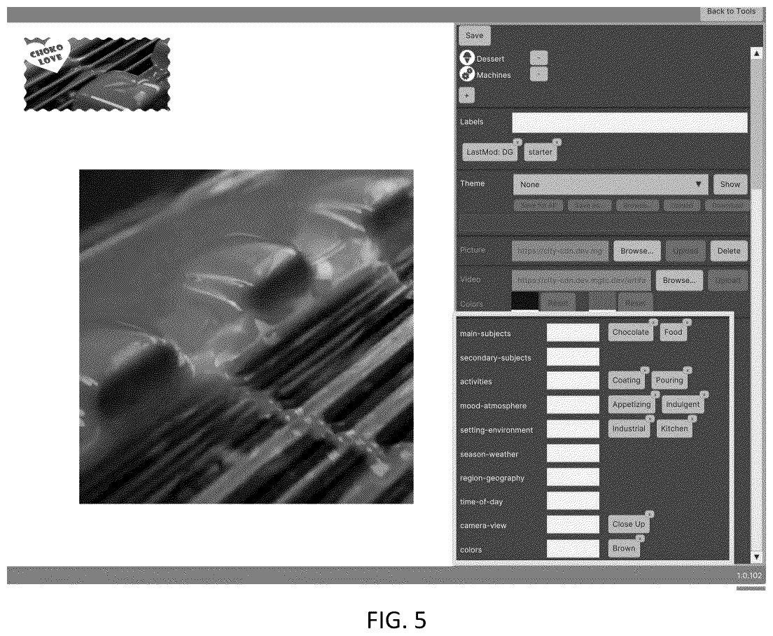

In some examples, the content analyzer 116 is configured to assign tags representing the content features identified in each category. FIG. 5 illustrates an example of tags assigned by the content analyzer 106. As shown, the user content 116 in the example corresponds to a chocolate manufacturing process. For the main-subjects category, the content analyzer 116 assigned tags of “Chocolate” and “Food.” Likewise, the content analyzer 116 assigned tags of “Coating” and “Pouring” for the activities category, tags of “Appetizing” and “Indulgent” for the mood/atmosphere category, tags of “Industrial” and “Kitchen” for the setting/environment category, a tag of “Close Up” for the camera view category, and a tag of “Brown” for the color category. In some examples, the assigned tags are presented to the user for review and/or editing (e.g., via the GUI).

At block 206, the element engine 108 obtains custom game elements corresponding to the content features identified in step 204. In this context, game elements refer to items that form the digital game 114. For example, the game elements may include pieces, icons, characters, animations, scenery, and/or colors of the digital game 114. In one example, the element engine 108 selects a theme based on the identified content features. In some examples, the theme is selected based on a mapping of the tags assigned in step 204. The theme may be selected from a plurality of predefined themes (e.g., stored in the element database 112a or the game database 112b).

Once the theme is selected, the element engine 108 retrieves custom game elements (e.g., from the element database 112a) that match the selected theme. In some examples, each theme has a plurality of pre-assigned custom game elements. In other examples, the element engine 108 is configure to search the element database 112a to identify game elements that match the selected theme. For example, if the theme is “Basketball”, the element engine 108 searches and selects game elements that look like, or are associated with, basketballs. Likewise, if the theme is a specific basketball team, the element engine 108 searches and selects game elements that look like basketballs and other game elements having the color scheme of the team.

In some examples, the element engine 108 is configured to retrieve custom game elements that correspond to a plurality of default game elements for the digital game 114. In this context, the default game elements represent the types of game elements that are present in the digital game 114 (or a level of the digital game 114). In other words, if the digital game 114 has five default game elements, the element engine 108 may retrieve/select up to five custom game elements to replace the default elements. In some examples, the element engine 108 may retrieve/select custom game elements to replace the entire plurality of default game elements. In other examples, the element engine 108 may retrieve/select custom game elements to replace a portion of the plurality of default game elements.

In some examples, the element engine 108 is configured to generate the custom game elements corresponding to the selected theme. In one example, the element engine 108 is configured to generate custom game elements by modifying the plurality of default game elements. For example, the element engine 108 may utilize element assets (e.g., colors, shapes, etc.) stored in the element database 112a. In other examples, the element engine 108 generates new custom elements to replace the default game elements (e.g., using element assets stored in the element database 112a). In some examples, the content engine 108 includes, or is configured to interface with, a generative AI tool (e.g., Open AI's DALL·E 3 tool) that is trained to generate content. In such examples, the content engine 108 constructs prompts based on the theme, the content features, and/or the assigned tags. The prompts are fed to the generative AI tool to generate the custom game elements.

As described above, the element engine 108 may obtain (e.g., retrieve or generate) custom game elements corresponding to a theme that is selected based on the content features (or tags) identified in step 204. However, it should be appreciated that the element engine 108 can obtain custom game elements using a direct mapping of the content features (or tags) to game elements. In other words, the element engine 108 may use the content features (or tags) to search and retrieve content elements from the element database 112a. Likewise, the element engine 108 may generate custom game elements based on a description of the content features (or tags), without a designated theme.

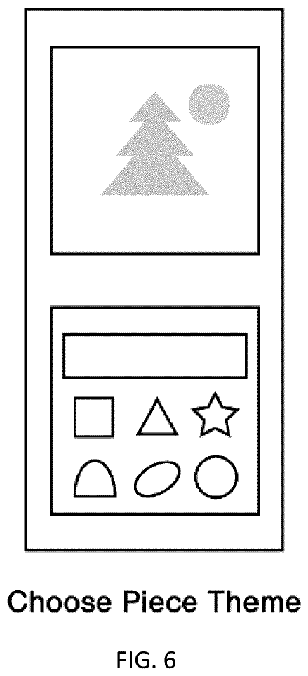

In some examples, the element engine 108 is configured to automatically obtain a single option for each custom game element. In some examples, the element engine is configured to obtain different options for each custom game element. In such examples, the element engine 108 may present the custom game elements to the user (e.g., via the GUI). For example, as shown in FIG. 6, different options for a game element (e.g., a game piece) may be presented to the user for selection.

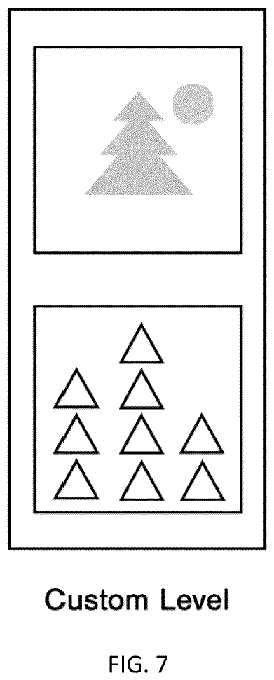

At block 208, the element engine 108 generates a custom appearance scheme for the digital game 114 that includes the custom game elements. In some examples, the custom appearance scheme is generated by modifying a default appearance scheme for the digital game 114. The element engine 108 may obtain the default appearance scheme from the game database 112b. In some examples, the default appearance scheme includes the plurality of default game elements arranged in their intended playable format. As such, the element engine 108 may generate the custom appearance scheme by replacing default game elements with the custom game elements obtained in step 206. In some examples, the custom appearance scheme is applied to the entire digital game (e.g., multiple levels, worlds, environments, etc.). In other examples, the custom appearance scheme is applied to a portion of the digital game (e.g., a specific level, world, environment, etc.). For example, FIG. 7 illustrates a custom appearance scheme that has been applied to a level of the digital game 114. In some examples, the element engine 108 (or the digital game 114) saves the custom appearance scheme in the game database 112b.

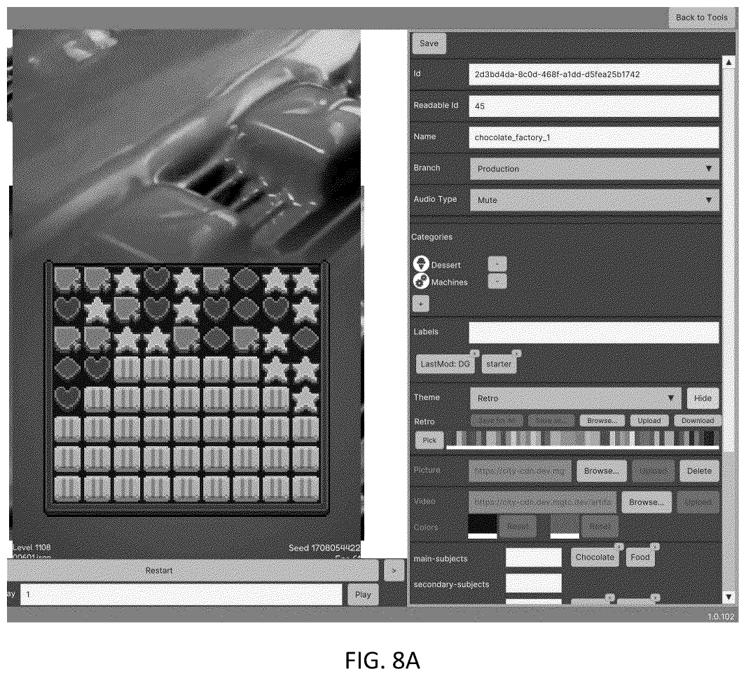

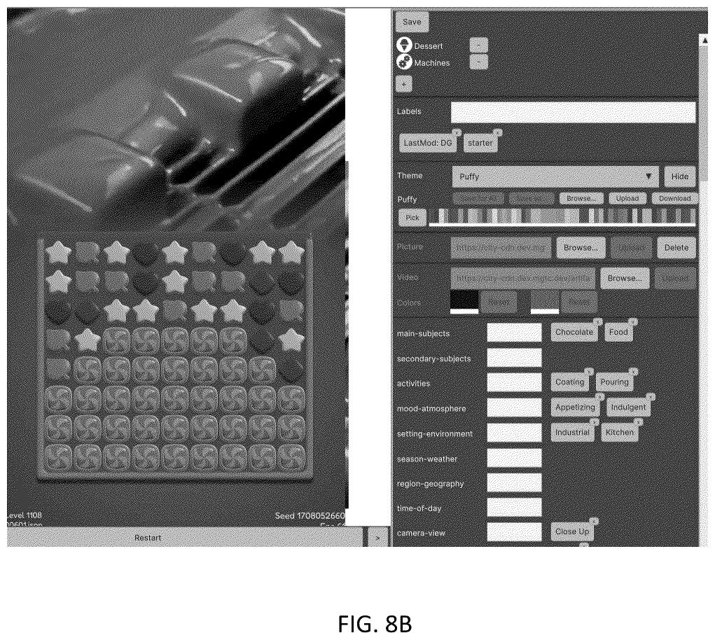

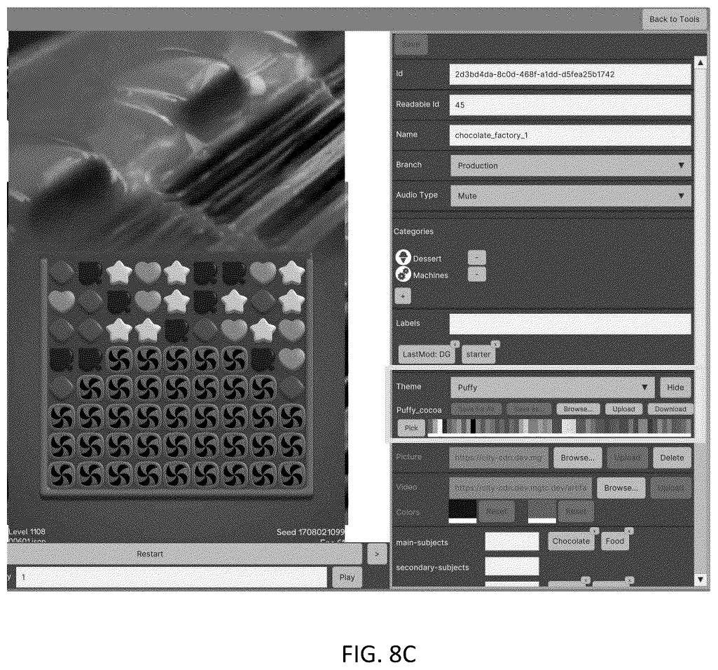

FIG. 8A illustrates an example of a custom appearance scheme generated by the element engine 108. As shown, the custom appearance scheme is generated based on a selected theme of “Retro” for the user content 116. The custom appearance scheme includes retro-themed game elements (e.g., pieces and blockers) that were obtained by the element engine 108. FIG. 8B illustrates an example of a different custom appearance scheme. As shown, the custom appearance scheme is generated based on a selected theme of “Puffy” for the user content 116. The custom appearance scheme includes puffy-themed game elements (e.g., pieces and blockers) that were obtained by the element engine 108. In some examples, a color scheme (or palette) is selected for the theme that corresponds to the colors in the user content 116. The color scheme may be applied to the game elements to further customize the appearance of the digital game 114. For example, FIG. 8C illustrates a custom appearance scheme that is the same as the custom appearance scheme of FIG. 8B, except a color scheme has been applied to the game elements to match the user content 116.

As described above, the element engine 108 is configured to obtain custom game elements based on content features (or tags) that are derived from the user content 116. However, in some instances, the content features include licensed content (e.g., names, entities, teams, brands, etc.). As such, the element engine 108 may be configured to evaluate the content features to determine if the content features correspond to licensed content. In some examples, the element engine 108 performs the evaluation based on a description of the content features and/or the assigned tags. In some examples, the element engine 108 is configured to send the content features and/or the assigned tags to another service to perform the evaluation. In some examples, the element engine 108 (or another service) performs the evaluation using the user content 116 (e.g., using a reverse image search).

In response to a determination that the content features do include licensed content, the element engine 108 is configured to query the license database 112c to determine whether the digital game 114 has a license to use the licensed content. If an appropriate license is available, the element engine 108 may proceed as described in steps 206 and 208 of the method 200. If no appropriate license is available, the content engine 108 can respond in several different ways. In some examples, the content engine 108 is configured to reject the licensed content by sending an alert to the user (e.g., via the digital game 114). The alert may notify the user that the user content 116 is unavailable for use. In some examples, the digital game 114 prompts the user to upload different content. In other examples, the content engine 108 may proceed using only generic (unlicensed) attributes of the license content (e.g., basic colors). In some examples, the content engine 108 is configured to send a message to the GMP 104 regarding the user's attempt to use the licensed content. The GMP 104 may log the messages and monitor related requests from other users. Once a request threshold has been met, the GMP 104 may send a request to the manager (or owner) of the digital game 114 to obtain an appropriate license given the user demand to use the licensed content.

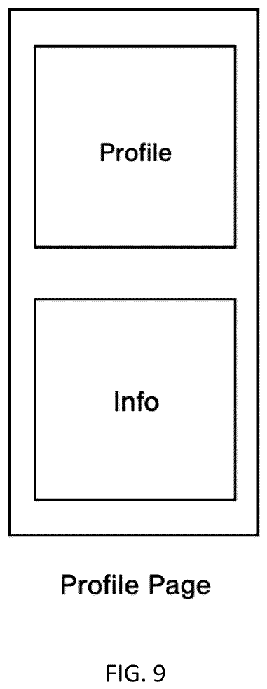

In some examples, the custom appearance scheme(s) generated by the user are made available to other users of the digital game 114. For example, each custom appearance scheme that the user generates for the digital game 114 may include a unique ID that is linked to the user (e.g., via a user ID). In some examples, the custom appearance schemes created by each user are displayed on a profile page associated with the user (e.g., see FIG. 9). The custom appearance schemes created by each user may be made available in a digital marketplace within the digital game 114. In some examples, the custom appearance schemes are made available for purchase using national currencies, cryptocurrencies, or in-game currencies (e.g., tokens). In some examples, the creator of each custom appearance scheme receives a royalty for each purchase (e.g. in the form of national currencies, cryptocurrencies, or in-game currencies). The digital game 114 may allow users to follow other users, such that they are notified each time a user generates a new custom appearance scheme. In some examples, the digital game 114 provides metrics that track and/or rank the popularity of each user's custom appearance schemes.

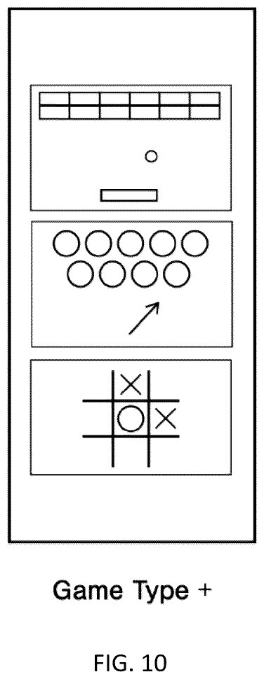

While the examples described above relate to generating custom appearance schemes for an existing game (e.g., digital game 114), it should be appreciated that similar techniques may be applied when creating a new digital game. As shown in FIG. 10, the GUI of the digital game 114 may present a plurality of game types for user's selection. In some examples, the plurality of game types are stored in the game database 112b. The user can select the type of game that they would like to associate the user content 116 with. In some examples, the plurality of game types are presented to the user after the user has uploaded the user content 116. In some examples, the plurality of game types is prefiltered based on compatibility with the user content 116. In other examples, the plurality of game types are presented to the user before the user has uploaded the user content 116.

### Hardware and Software Implementations

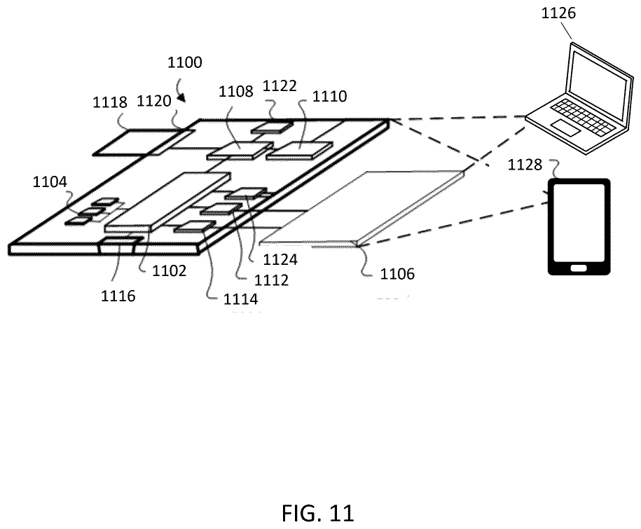

FIG. 11 shows an example of a computing device 1100, which may be used with some of the techniques described in this disclosure. Computing device 1100 includes a processor 1102, memory 1104, an input/output device such as a display 1106, a communication interface 1108, and a transceiver 1110, among other components. The device 1100 may also be provided with a storage device, such as a micro-drive or other device, to provide additional storage. Each of the components 1100, 1102, 1104, 1106, 1108, and 1110, are interconnected using various buses, and several of the components may be mounted on a common motherboard or in other manners as appropriate.

The processor 1102 can execute instructions within the computing device 1100, including instructions stored in the memory 1104. The processor 1102 may be implemented as a chipset of chips that include separate and multiple analog and digital processors. The processor 1102 may provide, for example, for coordination of the other components of the device 1100, such as control of user interfaces, applications run by device 1100, and wireless communication by device 1100.

Processor 1102 may communicate with a user through control interface 1112 and display interface 1114 coupled to a display 1106. The display 1106 may be, for example, a TFT LCD (Thin-Film-Transistor Liquid Crystal Display) or an OLED (Organic Light Emitting Diode) display, or other appropriate display technology. The display interface 1114 may comprise appropriate circuitry for driving the display 1106 to present graphical and other information to a user. The control interface 1112 may receive commands from a user and convert them for submission to the processor 1102. In addition, an external interface 1116 may be provided in communication with processor 1102, so as to enable near area communication of device 1200 with other devices. External interface 1116 may provide, for example, for wired communication in some implementations, or for wireless communication in other implementations, and multiple interfaces may also be used.

The memory 1104 stores information within the computing device 1100. The memory 1104 can be implemented as one or more of a computer-readable medium or media, a volatile memory unit or units, or a non-volatile memory unit or units. Expansion memory 1118 may also be provided and connected to device 1100 through expansion interface 1120, which may include, for example, a SIMM (Single In Line Memory Module) card interface. Such expansion memory 1118 may provide extra storage space for device 1100, or may also store applications or other information for device 1100. Specifically, expansion memory 1118 may include instructions to carry out or supplement the processes described above, and may include secure information also. Thus, for example, expansion memory 1118 may be provided as a security module for device 1100, and may be programmed with instructions that permit secure use of device 1100. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 1104, expansion memory 1118, memory on processor 1102, or a propagated signal that may be received, for example, over transceiver 1110 or external interface 1116.

Device 1100 may communicate wirelessly through communication interface 1108, which may include digital signal processing circuitry where necessary. Communication interface 1108 may in some cases be a cellular modem. Communication interface 1108 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 1110. In addition, short-range communication may occur, such as using a Bluetooth, WiFi, or other such transceiver (not shown). In addition, GPS (Global Positioning System) receiver module 1122 may provide additional navigation- and location-related wireless data to device 1100, which may be used as appropriate by applications running on device 1100.

Device 1100 may also communicate audibly using audio codec 1124, which may receive spoken information from a user and convert it to usable digital information. Audio codec 1124 may likewise generate audible sound for a user, such as through a speaker, e.g., in a handset of device 1100. Such sound may include sound from voice telephone calls, may include recorded sound (e.g., voice messages, music files, etc.) and may also include sound generated by applications operating on device 1100. In some examples, the device 1100 includes a microphone to collect audio (e.g., speech) from a user. Likewise, the device 1100 may include an input to receive a connection from an external microphone.

The computing device 1100 may be implemented in a number of different forms, as shown in FIG. 11. For example, it may be implemented as a computer (e.g., laptop) 1126. It may also be implemented as part of a smartphone 1128, smart watch, tablet, personal digital assistant, or other similar mobile device.

Some implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language resource), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending resources to and receiving resources from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method for customizing the appearance of a digital game, comprising:
receiving content from a user;
analyzing the content to identify at least one content feature;
obtaining at least one custom game element corresponding to the at least one content feature; and
generating a custom appearance scheme for the digital game that includes the at least one custom game element.

2. The method of claim 1, further comprising:
applying the custom appearance scheme to a level of the digital game.

3. The method of claim 1, further comprising:
obtaining a default appearance scheme for the digital game including a plurality of default game elements,
wherein generating the custom appearance scheme for the digital game includes replacing at least one default game element with the at least one custom game element.

4. The method of claim 1, wherein obtaining the at least one custom game element includes selecting the at least one custom game element from a game element library.

5. The method of claim 4, wherein the game element library is stored in at least one database.

6. The method of claim 1, wherein obtaining the at least one custom game element includes generating the at least one custom game element.

7. The method of claim 1, further comprising:
evaluating the at least one content feature to determine if the at least one content feature corresponds to licensed content; and
in response to a determination that the at least one content feature corresponds to licensed content, determining whether the digital game has a license to use the licensed content.

8. The method of claim 7, wherein determining whether the digital game has a license to use the licensed content includes querying at least one database.

9. The method of claim 1, wherein the content includes a video, an image, a GIF, or any combination thereof.

10. The method of claim 1, wherein the content features include items represented in the content, entities associated with the content, colors represented in the content, text represented in the content, or any combination thereof.

11. The method of claim 1, wherein the at least one custom game element includes pieces, icons, characters, scenery, colors, or any combination thereof.

12. A system for customizing the appearance of a digital game, comprising:
at least one memory for storing computer-executable instructions; and
at least one processor for executing the instructions stored on the at least one memory, wherein execution of the instructions programs the at least one processor to perform operations comprising:
receiving content from a user;
analyzing the content to identify at least one content feature;
obtaining at least one custom game element corresponding to the at least one content feature; and
generating a custom appearance scheme for the digital game that includes the at least one custom game element.

13. The system of claim 12, wherein the instructions, when executed, further instruct the at least one processor to perform operations comprising:
applying the custom appearance scheme to a level of the digital game.

14. The system of claim 12, wherein the instructions, when executed, further instruct the at least one processor to perform operations comprising:
obtaining a default appearance scheme for the digital game including a plurality of default game elements,
wherein generating the custom appearance scheme for the digital game includes replacing at least one default game element with the at least one custom game element.

15. The system of claim 12, wherein obtaining the at least one custom game element includes selecting the at least one custom game element from a game element library.

16. The system of claim 15, wherein the game element library is stored in at least one database.

17. The system of claim 12, wherein obtaining the at least one custom game element includes generating the at least one custom game element.

18. The system of claim 12, wherein the instructions, when executed, further instruct the at least one processor to perform operations comprising:
evaluating the at least one content feature to determine if the at least one content feature corresponds to licensed content; and
in response to a determination that the at least one content feature corresponds to licensed content, determining whether the digital game has a license to use the licensed content.

19. The system of claim 18, wherein determining whether the digital game has a license to use the licensed content includes querying at least one database.

20. The system of claim 12, wherein the content includes a video, an image, a GIF, or any combination thereof.

21. The system of claim 12, wherein the content features include items represented in the content, entities associated with the content, colors represented in the content, text represented in the content, or any combination thereof.

22. The system of claim 12, wherein the at least one custom game element includes pieces, icons, characters, scenery, colors, or any combination thereof.
